(19) United States
(12) Patent Application Publication
(10) Pub. No.: US 2010/0231655 A1
(43) Pub. Date: Sep. 16, 2010

(54) INKJET-PRINTING DEVICE PRINTHEAD DIE HAVING EDGE PROTECTION LAYER FOR HEATING RESISTOR

(75) Inventors: Bradley D. Chung, Corvallis, OR (US); Arun K. Agarwal, Corvallis, OR (US); Galen P. Cook, Corvallis, OR (US); Sadiq Bengali, Corvallis, OR (US); Christopher A. Leonard, Philomath, OR (US)

Correspondence Address: HEWLETT-PACKARD COMPANY;Intellectual Property Administration, 3404 E. Harmony Road, Mail Stop 35, FORT COLLINS, CO, 80528, US

(73) Assignee: Hewlett-Packard Developement Company, L.P., Houston, TX (US)

(21) Appl. No.: 12/739,066

(22) PCT Filed: Nov. 24, 2007
(86) PCT No.: PCT/US07/85479

§ 371 Date: Apr. 21, 2010

(51) Int. Cl. B41J 2/05

(52) U.S. Cl. 347/62

(57) ABSTRACT

A printhead die (200) for an inkjet-printing device includes a substrate (302), a heating resistor, and an edge protection layer (209) The heating resistor is formed on the substrate, and has one or more edges The heating resistor is operative to cause an ink droplet to be ejected from the inkjet-printing device upon sufficient current flowing through the heating resistor resulting in a bubble nucleating within ink at the heating resistor and thereafter collapsing at the heating resistor The edge protection layer covers just the edges of the heating resistor in order to at least substantially protect the heating resistor from becoming damaged due to collapsing of the bubble at the heating resistor

### BACKGROUND

Inkjet-printing devices operate by ejecting ink via a printhead die onto a medium like paper to form an image on the medium. The printhead die is a relatively small semiconductor part that typically has many intricate components which have to be precisely fabricated in order for the die to operate properly. Many printhead dies include a silicon substrate and a device layer over the substrate. The device layer may include transistors, a heating resistor, and other components to permit the die to operate properly.

In thermal inkjet-printing devices in particular, sufficient current is caused to flow through the heating resistors to eject ink droplets. In particular, sufficient current flowing through a heating resistor heats the heating resistor, which results in a bubble nucleating within the ink at the heating resistor to eject a droplet of the ink. Thereafter, the bubble collapses. Bubble collapse is relatively violent, and can damage the heating resistor, such that the inkjet-printing device in question no longer operates properly.

### BRIEF DESCRIPTION OF THE DRAWINGS

FIGS. 1A and 1B are diagrams depicting bubble nucleation and collapse to cause ink droplet ejection but that can result in a heating resistor to become damaged, according to the prior art.

FIGS. 2A and 2B are diagrams depicting bubble nucleation and collapse to cause ink droplet ejection in which the heating resistor is protected by an edge protection layer to at least substantially prevent the heating resistor from becoming damaged, according to an embodiment of the present disclosure.

FIG. 3 is a cross-sectional diagram depicting at least some of the layers of an inkjet-printing device printhead die, according to an embodiment of the present disclosure.

FIG. 4 is a flowchart of a method for at least partially fabricating an inkjet-printing device printhead die, according to an embodiment of the present disclosure.

FIG. 5 is a diagram of a representative inkjet-printing device printhead assembly, according to an embodiment of the present disclosure.

FIG. 6 is a block diagram of a rudimentary inkjet-printing device, according to an embodiment of the present disclosure.

### DETAILED DESCRIPTION OF THE DRAWINGS

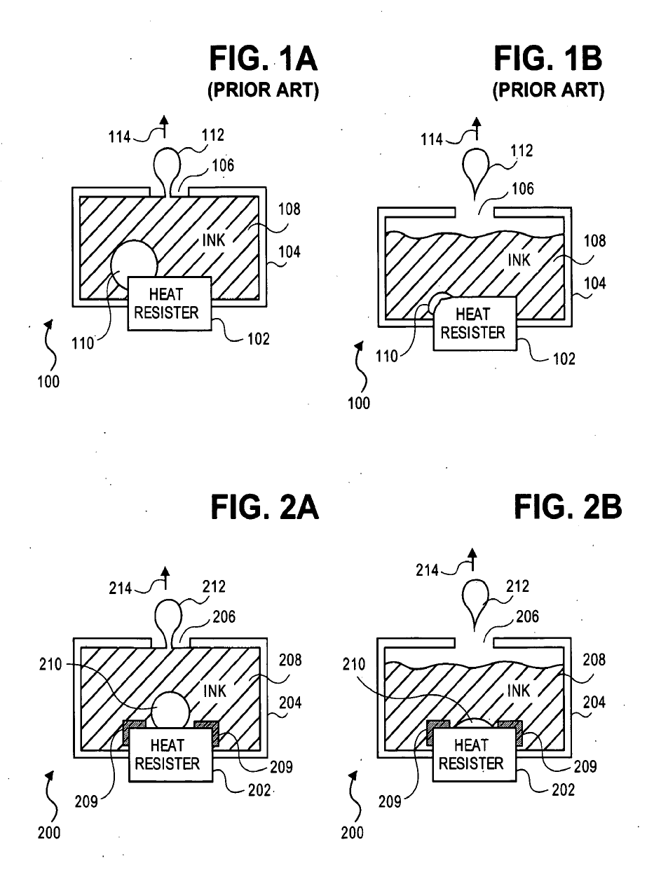

FIGS. 1A and 1B illustratively depict ink droplet ejection from an inkjet-printing device printhead die 100 via bubble nucleation and collapse, which can result in a heating resistor 102 becoming damaged, according to the prior art. The inkjet-printing device printhead die 100 includes the heating resistor 102 at the bottom of a firing chamber 104, where there is an orifice 106 at the top of the firing chamber 104. The firing chamber 104 contains a small amount of ink 108. It is noted that the printhead die 100 may and typically does include additional components, besides those depicted in FIGS. 1A and 1B. Furthermore, it is noted that the components of the printhead die 100 are not depicted in the way in which these components actually appear in a real printhead die, but rather are stylized in a way that operation of the printhead die 100 in accordance with the prior art is more readily understood.

In FIG. 1A, sufficient current is caused to flow through the heating resistor 102 to heat the resistor 102. This results in a bubble 110 nucleating at the heating resistor 102 within the firing chamber 104. In the specific example of FIG. 1A, the bubble 110 is formed at an edge of the heating resistor 102. Nucleation, or formation, of the bubble 110 within the firing chamber 104 forces an ink droplet 112 to be ejected from the ink 108 contained within the chamber 104 through the orifice 106, as indicated by the arrow 114.

In FIG. 1B, the ink droplet 112 has been completely ejected from the ink 108 contained within the firing chamber 104 through the orifice 106, as indicated by the arrow 114. Furthermore, the bubble 110 has collapsed at the heating resistor 102 within the firing chamber 104. Collapse of the bubble 110 is relatively violent, and in the example of FIG. 1B has resulted in the heating resistor 102 becoming damaged at the edge thereof at which the bubble 110 Was nucleated and subsequently had collapsed. As such, the heating resistor 102 may no longer operate properly, and further ink droplets may not be able to be ejected from the printhead die 100.

By comparison, FIGS. 2A and 2B illustratively depict ink droplet ejection from an inkjet-printing device printhead die 200 via bubble nucleation and collapse, where a heating resistor 202 is protected from becoming damaged, according to an embodiment of the present disclosure. The inkjet-printing device printhead die 200 includes the heating resistor 202 at the bottom of a firing chamber 204, where there is an orifice 206 at the top of the firing chamber 204. The firing chamber 204 contains a small amount of ink 208.

Furthermore, the inkjet-printing device printhead die 200 includes an edge protection layer 209 that protects the edges of the heating resistor 202. It is noted that the printhead die 200 may and typically does include additional components, besides those depicted in FIGS. 2A and 2B, as can be appreciated by those of ordinary skill within the art. It is also noted that the components of the printhead die 200 are not depicted in the way in which these components actually appear in a real printhead die, but rather are stylized in a way that operation of the printhead die 200 in accordance with an embodiment of the present disclosure is more readily understood.

In FIG. 2A, sufficient current is caused to flow through the heating resistor 202 to heat the resistor 202. This results in a bubble 210 nucleating at the heating resistor 202 within the firing chamber 204. In one embodiment, the presence of the edge protection layer 209 at the edges of the heating resistor 202 at least substantially inhibits the bubble 210 from nucleating at these edges. For instance, the edge protection layer 209 may have a sufficient thickness and/or sufficient thermal properties that militate against the bubble 210 from nucleating, or forming, at the edges of the heating resistor 202. Rather, as depicted in FIG. 2A, the bubble nucleates at the primary body portion of the heating resistor 202, which can be defined as the length of the heating resistor 202 inwards from the edges of the resistor 202. Nucleation of the bubble 210 within the firing chamber 204 forces an ink droplet 212 to be ejected from the ink 208 containing within the chamber 204 through the orifice 206, as indicated by the arrow 214.

In FIG. 2B, the ink droplet 212 has been completely ejected from the ink 208 contained within the firing chamber 204 through the orifice 206, as indicated by the arrow 214. Furthermore, the bubble 210 has collapsed at the heating resistor 202 within the firing chamber. However, in one embodiment, insofar as the edge protection layer 209 inhibits the bubble 210 from nucleating at the edges of the heating resistor 202, such that the bubble 210 has instead nucleated at the primary body portion of the resistor 202, and the heating resistor 202 is substantially prevented from becoming damaged due to collapse of the bubble 210.

In another embodiment, the bubble 210 may still nucleate and then collapse at an edge of the heating resistor 202 even where the edge protection layer 209 is present. However, the edge protection layer 209 nevertheless has a sufficient thickness and/or sufficient thermal properties that protect the heating resistor 202 from becoming damaged by the bubble 210 collapsing at the edges of the heating resistor 202. For instance, the edge protection layer 209 may absorb the physical shock resulting from collapse of the bubble 210, such that the edges of the heating resistor 202 are less likely to become damaged as a result of the collapse, of the bubble 210.

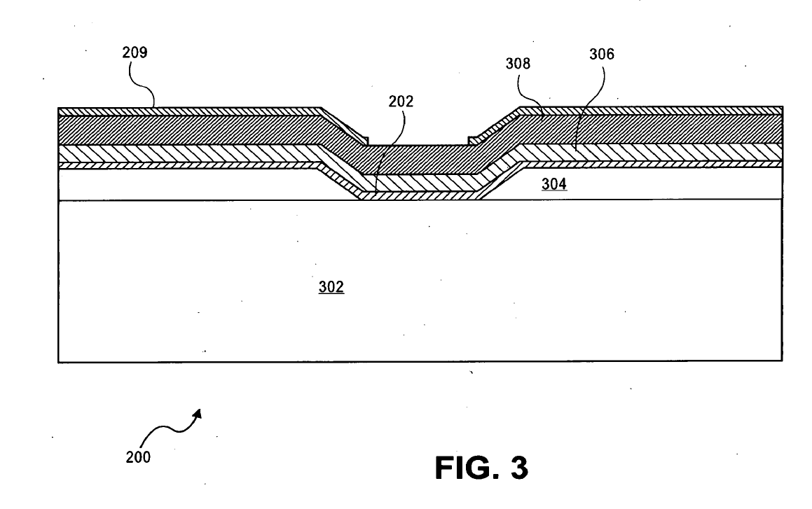

FIG. 3 shows a cross section of a portion of the inkjet-printing device printhead die 200, according to an embodiment of the present disclosure. The printhead die 200 includes a substrate 302, a metal layer 304, the heating resistor 202, a passivation layer 306, a cavitation layer 308, and the edge protection layer 209. Those of ordinary skill within the art can appreciate that the printhead die 200 may include additional components or layers, in addition to and/or in lieu of those depicted in FIG. 3. For instance, the firing chamber 204 and the orifice 206 of FIGS. 2A and 2B are not particularly depicted in FIG. 3 for illustrative clarity and convenience.

The substrate 302 may be a silicon substrate, or another type of substrate. A metal layer 304 is disposed over the substrate 302. The metal of the metal layer 304 may be aluminum, an aluminum alloy, or another type of conductive material. The heating resistor 202 is depicted in FIG. 3 as depicted as disposed on top of and within the middle of the metal layer 304. The heating resistor 202 may be fabricated from a partially conductive and a partially non-conductive material sufficient to result in the resistor 202 becoming heated when a given amount of current is caused to flow through the heating resistor 202 via the metal layer 304.

A passivation layer 306, which may be fabricated from a combination of materials such as silicon nitride and silicon carbide, may be disposed over the heating resistor 202. The ink that is used in the inkjet-printing device of which the printhead die 200 is a part may, for instance, be at least partially conductive. As such, the passivation layer 306 electrically insulates the metal layer 304 and the heating resistor 202 from this ink. The passivation layer 306 may also function as a passivation layer that provides an initial layer of protection for the heating resistor 202. A cavitation layer 308, which may be fabricated from tantalum, may be disposed over the passivation layer 306. The cavitation layer 308 is designed to protect the underlayers from damage due to bubble collapse; however, it often does not protect the underlayers adequately throughout the life of the printhead die 200, particularly around its edges.

An edge protection layer 209 is disposed over the passivation layer 306 and the cavitation layer 308 in particular, and over the substrate 302, the heating resistor 202, and the metal layer 304 in general. The edge protection layer 209 is specifically disposed over the heating resistor 202 in that it extends over the edges of the heating resistor 202, as is depicted in FIG. 3. As such, the edge protection layer 209 does not extend over the primary body portion of the heating resistor 202, between the edges of the heating resistor 202. In this way, it can be said that the edge protection layer 209 covers just the edges of the heating resistor 202.

As has been noted, the edge protection layer 209 may have sufficient thermal properties and/or a sufficient thickness to at least substantially prevent bubble nucleation and thus bubble collapse at (i.e., over) the edges of the heating resistor 202. Additionally or alternatively, the edge protection layer 209 may have sufficient thermal properties and/or a sufficient thickness to decrease the likelihood that the edges of the heating resistor 202 will become damaged by subsequent bubble collapse even if the bubble nucleates and then collapses at the edges of the heating resistor 202. In either or both of these ways, it can be said that the edge protection layer 209 at least substantially protects the heating resistor 202 from becoming damaged due to bubble collapse at the heating resistor 202.

In one embodiment, the edge protection layer 209 is part of a photoresist layer, such that the edge protection layer 209 is fabricated from photoresist, and such that the layer 209 as depicted in FIG. 3 also illustratively represents such a photoresist layer. The edge protection layer 209 may have a height or thickness of four microns where the layer 209 is photoresist, which has been found to be a sufficient thickness to at least substantially protect the heating resistor 202 from becoming damaged due to bubble collapse, taking into account the thermal properties of photoresist. Furthermore, in this embodiment, the photoresist layer may ordinarily and normally be formed as part of the fabrication process of the printhead die 200. As such, this embodiment can be advantageous because it does not add any additional processing steps to the fabrication process of the printhead die 200. Rather, the mask that is used to deposit and/or pattern the photoresist layer is just modified so that formation of the photoresist layer also encompasses and/or includes formation of the edge protection layer 209 that is a part of the photoresist layer. In one embodiment, the photoresist may be a photo-imageable epoxy such as that which is known as SU8, available from MicroChem Corp. of Newton, Mass. In this embodiment, the photoresist layer can also thus be considered an epoxy layer.

In another embodiment, the edge protection layer 209 may be a silicon carbide layer. In this embodiment, the edge protection layer 209 may have a width that is lesser than is depicted in FIG. 3, such that the edge protection layer 209 does not extend substantially away from the heating resistor 202 to the left and to the right in FIG. 3 past covering the edges of the heating resistor 202. Where the edge protection layer 209 is a silicon carbide layer, it may have a height or thickness of between 0.01 micron and 10 microns in various embodiments, which have been found to be sufficient thicknesses to at least substantially protect the heating resistor 202 from becoming damaged due to bubble collapse, taking into account the thermal properties of silicon carbide. The edge protection layer 209 can also be fabricated from a material other than photoresist, epoxy, or silicon carbide, as to which specific embodiments of the present disclosure have been described.

It is noted that the presence or inclusion of the edge protection layer 209 over the edges over the heating resistor 202 can decrease the average ink droplet weight of ink droplets ejected from the inkjet-printing device of which the printhead die 200 is a part unless otherwise accounted for. This may be because where there is less surface area of the heating resistor 202 from which heat can be transferred to the ink, such that a smaller bubble may nucleate within the ink, resulting in a smaller and thus less heavy ink droplet. Therefore, in one embodiment, the heating resistor is increased in size—such as from left to right in FIG. 3 and/or into and out of the plane of the sheet of FIG. 3—so compensate for the presence of the edge protection layer 209. In such an embodiment, therefore, the end result is that there is substantially no decrease in the average ink droplet weight of the ink droplets ejected from the inkjet-printing device of which the printhead die 200 is a part due to the presence of the edge protection layer 209.

It is finally noted that the metal layer 304 may be more generally considered to be part of a device layer, which in FIG. 3 can be said to be illustratively represented by the layer 304. Such a device layer includes the heating resistor 202, as well as other thin-film and other devices of the printhead die 200. For instance, as can be appreciated by those of ordinary skill within the art, the device layer may include one or more thin-film transistors fabricated over and/or at least partially within the substrate 302. Such transistors may include gates, sources, and drains, as is customary, and which are not particularly depicted in FIG. 3 for illustrative clarity and convenience.

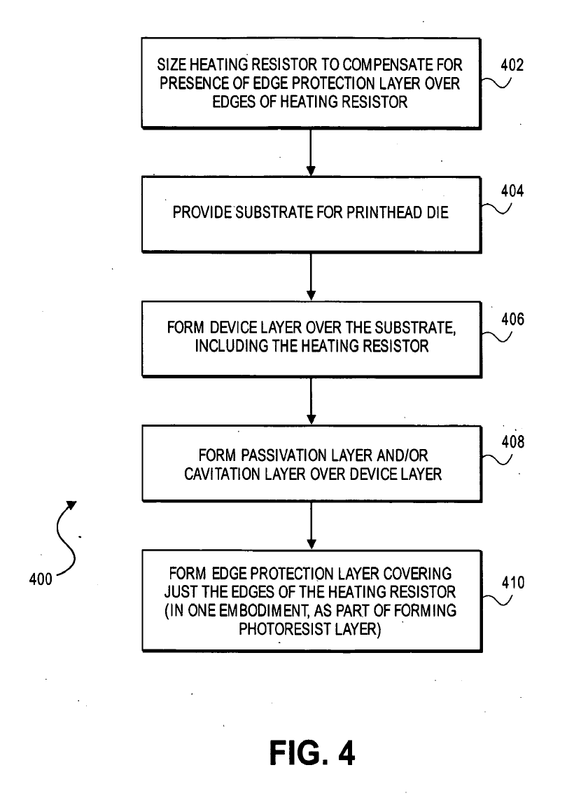

FIG. 4 shows a method 400 for at least partially fabricating the inkjet-printing device printhead die 200, according to an embodiment of the present disclosure. It is noted that just some parts of the fabrication process are particularly depicted in FIG. 4 and described herein. Those of ordinary skill within the art can thus appreciate that other parts may be performed to complete the fabrication of the printhead die 200. In particular, just the parts relevant to embodiments of the present disclosure are depicted in FIG. 4 and described herein.

In one embodiment, the heating resistor 202 may be sized to compensate for the subsequent presence of the edge protection layer 209 over the edges of the heating resistor 202 (402). In such an embodiment, then, the presence of the edge protection layer 209 does not decrease average ink droplet weight of ink droplets ejected from the printhead die 200. Correctly sizing the heating resistor 202 in this respect may include empirically determining how much the heating resistor 202 should be increased in surface area in relation to the ink so that average ink droplet weight substantially does not decrease.

The substrate 302, such as a silicon substrate, is provided (404). A device layer is formed over the substrate 302 (406). The device layer includes at least the heating resistor 202, which may have a size as has been determined in part 402. The device layer can further include or be the metal layer 304, and can include other types of devices, such as thin-film transistors, as has been described. Thereafter, in one embodiment, the passivation layer 306 and the cavitation layer 308 may be deposited over the device layer (408).

The edge protection layer 209 is then formed (410). As has been described, the edge protection layer 209 covers just the edges of the heating resistor 202, and not the primary body portion of the heating resistor 202. In one embodiment, forming the edge protection layer 309 may be performed as part of forming a photoresist layer that would otherwise still have to be formed even if the edge protection layer 209 were not formed. In such an embodiment, as has been described, this means that the formation of the edge protection layer 209 does not result in additional processing steps to fabricate the printhead die 200.

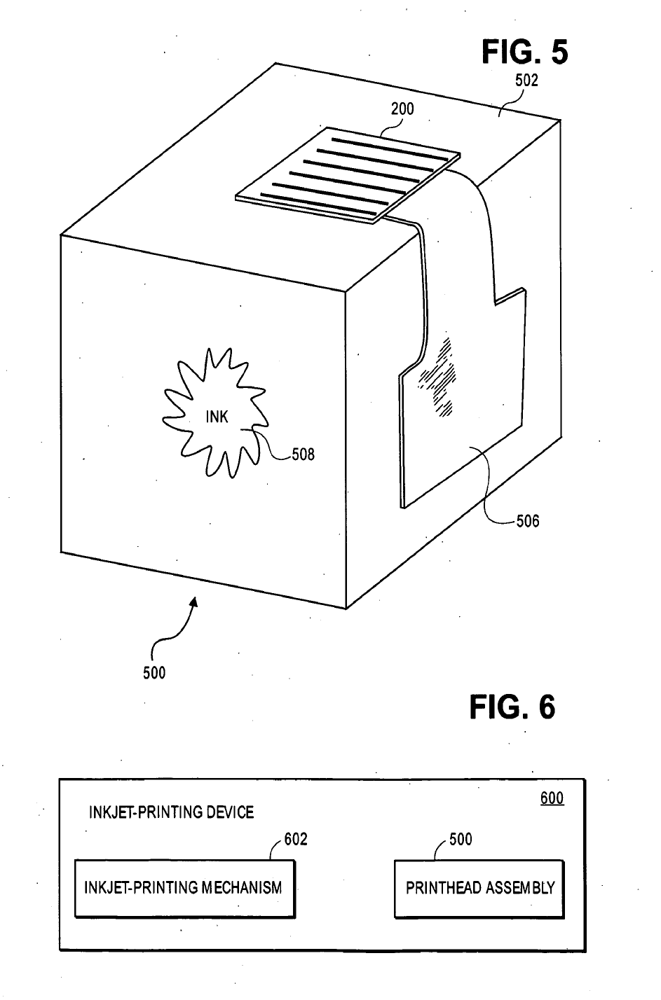

FIG. 5 shows a representative inkjet-printing device printhead assembly 500, according to an embodiment of the present disclosure. The printhead assembly 500 includes an enclosure cartridge 502. The enclosure cartridge 502, and thus the printhead assembly 500, is insertable into a corresponding slot of an inkjet-printing device, so that the device can eject ink on a medium like paper to form an image on the medium.

The printhead assembly 500 includes the printhead die 200 that has been described, and also a flexible circuit 506 to which the printhead die 200 is electrically connected. The printhead die 200 is typically a small semiconductor die, which is depicted in FIG. 5 as being proportionally larger than it actually is in relation to the flexible circuit 506 and the enclosure cartridge 502 for illustrative clarity. The flexible circuit 506 electrically mates to a corresponding electrical connector of an inkjet-printing device upon the enclosure cartridge 502 being removably inserted or installed into the inkjet-printing device. The flexible circuit 506 specifically can include conductor traces from the printhead die 200 so that the die 200 can be electrically coupled to the inkjet-printing device. The circuit 506 is flexible so that it can bend around one or more edges of the enclosure cartridge 502, as depicted in FIG. 5.

In the embodiment of FIG. 5, the printhead assembly 500 also includes a supply of ink 508, which is contained within the interior of the enclosure cartridge 502. However, in another embodiment, the supply of ink 508 may be contained in an assembly that is separate from the printhead assembly 500. In general, the inkjet-printing device into which the printhead assembly 500 has been installed causes the printhead die 200 to eject droplets of the ink 508 through the die to form an image on a medium like paper.

In conclusion, FIG. 6 shows a rudimentary inkjet-printing device 600, according to an embodiment of the present disclosure. The inkjet-printing device 600 may be an inkjet printer, or a multifunction device (MFD) or an all-in-one (AIO) that can include other functionality in addition to inkjet-printing functionality. The inkjet-printing device 600 is depicted in FIG. 6 as including the printhead assembly 500 that has been described and an inkjet-printing mechanism 602. Those of ordinary skill within the art can appreciate that the inkjet-printing device 600 can and typically will include other components, in addition to those depicted in FIG. 6.

The inkjet-printing mechanism 602 includes those components by which the inkjet-printing device 600 forms images on media such as paper by, for instance, thermally ejecting ink onto the media. The printhead assembly 500 may thus share components with the inkjet-printing mechanism 602. That is, the printhead assembly 500 includes the printhead die 200 that actually causes ink to be ejected. To this extent, the inkjet-printing mechanism 602 can be said to share the printhead die 100 with the printhead assembly 500. Other components that the inkjet-printing mechanism 602 can include are firmware, media advancement motors, and so on, as can be appreciated by those of ordinary skill within the art.

We claim:

1. A printhead die (200) for an inkjet-printing device, comprising:
a substrate (302);
a heating resistor (202) formed on the substrate, the heating resistor having one or more edges, the heating resistor operative to cause an ink droplet to be ejected from the inkjet-printing device upon sufficient current flowing through the heating resistor resulting in a bubble nucleating within ink at the heating resistor and thereafter collapsing at the heating resistor; and,
an edge protection layer (209) covering just the edges of the heating resistor in order to at least substantially protect the heating resistor from becoming damaged due to collapsing of the bubble at the heating resistor.

2. The printhead die of claim 1, wherein the edge protection layer at least substantially prevents the bubble from nucleating at the edges of the heating resistor.

3. The printhead die of claim 1, wherein the edge protection layer decreases a likelihood that the heating resistor will become damaged even where the bubble nucleates at the edges of the heating resistor.

4. The printhead die of claim 1, wherein the edge protection layer covers just the edges of the heating resistor in that a primary body portion of the heating resistor remains at least substantially uncovered by and exposed through the edge protection layer.

5. The printhead die of claim 1, further comprising a photoresist layer including the edge protection layer.

6. The printhead die of claim 5, wherein the photoresist layer is ordinarily and normally formed as part of a fabrication process of the printhead die, such that forming the edge protection layer does not add any additional processing steps to the fabrication process of the printhead die.

7. The printhead die of claim 6, wherein the photoresist layer is extended to include the edge protection layer.

8. The printhead die of claim 1, wherein presence of the edge protection layer results in a decrease in a weight of the ink droplet to be ejected from the inkjet-printing device unless otherwise accounted for.

9. The printhead die of claim 1, wherein the heating resistor is increased in size to compensate for presence of the edge protection layer so that there is substantially no decrease in a weight of the ink droplet to be ejected from the inkjet-printing device due to the presence of the edge protection layer.

10. A printhead assembly (500) for an inkjet-printing device, comprising:
a printhead die (200) comprising:
a substrate (302);
a heating resistor (202) formed on the substrate, the heating resistor having one or more edges, the heating resistor operative to cause an ink droplet to be ejected from the inkjet-printing device upon sufficient current flowing through the heating resistor resulting in a bubble nucleating within ink at the heating resistor and thereafter collapsing at the heating resistor; and,
an edge protection layer (209) covering just the edges of the heating resistor in order to at least substantially protect the heating resistor from becoming damaged due to collapsing of the bubble at the heating resistor; and,
a flexible circuit to electrically connect the printhead die to the inkjet-printing device.
